(19) United States
(12) Patent Application Publication
(10) Pub. No.: US 2008/0166965 A1
(43) Pub. Date: Jul. 10, 2008

(54) Wirelessly powered specialty lighting, motion, sound

(75) Inventors: Charles E. Greene, Cabot, PA (US); Daniel W. Harrist, Carnegie, PA (US); Michael Thomas McElhinny, Port Vue, PA (US); David Jeffrey Graham, Cranberry Township, PA (US)

Correspondence Address: Ansel M. Schwartz;Suite 304, 201 N. Craig Street, Pittsburgh, PA, 15213, US

(73) Assignee: Powercast Corporation

(21) Appl. No.: 12/006,547

(22) Filed: Jan. 3, 2008

Related U.S. Application Data
(60) Provisional application No. 60/878,885, filed on Jan. 4, 2007.

(51) Int. Cl. H04B 5/00

(52) U.S. Cl. 455/41.1

(57) ABSTRACT

Disclosed is a system for wirelessly powering an item. A source is configured to send wireless power. A target is configured to receive the wireless power and convert the wireless power to a useable power. A component is connected to and configured to receive the useable power from the target. When the component receives the usable power, the component activates. Also disclosed is an assembly including a system for wirelessly powering a component and a structure for supporting the system and an item.

### BACKGROUND OF THE INVENTION

1. Field of the Invention

The present invention is directed to specialty items, such as lighted decorations and Christmas trees, which are directly powered or recharged from a remote source.

2. Description of Related Art

It is known to have specialty items that are hard wired for power or utilize batteries for power. These wires can be cumbersome and unaesthetic and even a potential fire hazard. Batteries must eventually be replaced, and the more items there are, the more tedious becomes such a task. The present invention avoids these problems.

### BRIEF SUMMARY OF THE INVENTION

It is an object of this invention to provide a system for specialty items (devices) having one or more activated modes to affect a result or desired outcome, for example, to stimulate the senses. A mode may correlate to one or more of the senses—sight, sound, scent, taste, and touch. The items are powered and/or recharged using wireless RF power.

The specialty items may be, but are not limited to, decorations (holiday, theme, and general), props, displays, sensor (e.g., safety) assemblies, and Christmas trees. For example, the items may be ornaments, lights (bulbs, LEDs, EL, EL strings, rope lights, etc), tree toppers, centerpieces, home décor, landscape décor, emergency back-up lights, smoke/fire detectors. Applications with which the invention may be used are, for example, store displays, showrooms, window displays, Christmas trees (real or artificial), outdoor and/or indoor lighting systems, alarm systems.

It is another object of this invention to provide an assembly including a system for wirelessly powering a specialty item and a structure for mounting or supporting the system. For example, the structure may be a Christmas tree, a mannequin, a light post, a stand.

In general, a simple system according to the present invention includes a power transmitter (“transmitter”) and a power receiver (“receiver”). The power receiver is connected to a component of an item that requires power to be activated, where activation produces light, movement, sound, etc. or combinations thereof.

The system according to the present invention may be retrofitted onto/into an existing item, group of items, or structure or the system may be designed as an integral part of the item, group of items, or structure.

The present invention pertains to a system for wirelessly powering an item. The system comprises a source configured to send wireless power. The system comprises a target configured to receive the wireless power and convert the wireless power to a useable power. The system comprises a component connected to and configured to receive the useable power from the target, wherein when the component receives the usable power, the component activates and the active component can be sensed by a person.

The present invention pertains to an assembly. The assembly comprises a system for wirelessly powering a component. The assembly comprises a structure for supporting all or part the system. The system includes a source configured to send wireless power. The system includes a target electrically connected to the component and configured to receive the wireless power, to convert the wireless power to a useable power, and to activate a component using the useable power.

The present invention pertains to an item that is wirelessly powered. The item comprises a target configured to receive wireless power and convert the wireless power to a useable power. The item comprises a component connected to and configured to receive the useable power from the target, wherein when the component receives the usable power, the component activates, and the active component can be sensed by a person.

The present invention pertains to a method for wirelessly powering an item comprising the steps of sending wireless power from a source. There is the step of receiving the wireless power at a target. There is the step of converting the wireless power to a useable power at the target. There is the step of receiving the useable power from the target at a component connected to the target. There is the step of activating by the component when the component receives the usable power, wherein the active component can be sensed by a person.

The present invention pertains to a structure for supporting. The structure comprises a base. The structure comprises an element extending from the base having a first portion through which at least one wireless power transmitter is attached to the element, and a second portion through which at least one target configured to receive the wireless power and convert the wireless power to a useable power is attached to the element.

The present invention pertains to a system for wirelessly powering an item attached to a tree. The system comprises a source configured to send wireless power. The system comprises at least one target configured to receive the wireless power and convert the wireless power to a useable power wherein the at least one target is attached to the tree.

### BRIEF DESCRIPTION OF THE SEVERAL VIEWS OF THE DRAWINGS

FIG. 1 is an illustration of a first embodiment of a system for wirelessly powering an item according to the invention;

FIG. 2 is an illustration of a first embodiment of a source according to the present invention;

FIG. 3 is an illustration of a second embodiment of a source according to the present invention;

FIG. 4 is an illustration of a third embodiment of a source according to the present invention;

FIG. 5 is an illustration of a fourth embodiment of a source according to the present invention;

FIG. 6 is an illustration of a first embodiment of a target according to the present invention;

FIG. 7 is an illustration of a second embodiment of a target according to the present invention;

FIG. 8 is an illustration of a third embodiment of a target according to the present invention;

FIG. 9 is an illustration of a fourth embodiment of a target according to the present invention;

FIG. 10 is a fifth embodiment of a target according to the present invention;

FIG. 11 is a sixth embodiment of a target according to the present invention;

FIG. 12 is a seventh embodiment of a target according to the present invention;

FIG. 13 is an eighth embodiment of a target according to the present invention;

FIG. 14 is a ninth embodiment of a target according to the present invention;

FIG. 15 is an illustration of a tenth embodiment of a target according to the present invention;

FIG. 16 is an illustration of a eleventh embodiment of a target according to the present invention;

FIG. 17 is an illustration of an twelfth embodiment of a target according to the present invention;

FIG. 18 is an illustration of a first embodiment of an item according to the present invention;

FIG. 19 is an illustration of a second embodiment of a system for wirelessly powering an item according to the present invention;

FIG. 20 is an illustration of a third embodiment of a system for wirelessly powering an item according to the invention;

FIG. 21 is an illustration of a fourth embodiment of a system for wirelessly powering an item according to the invention;

FIG. 22 is an illustration of a second embodiment of an item according to the present invention;

FIG. 23 is an illustration of a first embodiment of an assembly including a system for wirelessly powering an item and a structure for supporting the system according to the present invention;

FIG. 24 is an illustration of a second embodiment of an assembly including a system for wirelessly powering an item and a structure for supporting the system according to the present invention;

FIG. 25 is an illustration of a third embodiment of an assembly including a system for wirelessly powering an item and a structure for supporting the system according to the present invention, showing point of emission and point of reception placement;

FIG. 26 is an illustration of a fourth embodiment of an assembly including a portion of a system for wirelessly powering an item and a structure for supporting the system according to the present invention, showing source placement;

FIG. 27 is an illustration of a fifth embodiment of an assembly including a portion of a system for wirelessly powering an item and a structure for supporting the system according to the present invention, showing source placement;

FIG. 28 is an illustration of a fifth embodiment of an assembly including a portion of a system for wirelessly powering an item and a structure for supporting the system according to the present invention, showing source placement;

FIG. 29 is an illustration of a target that is removable allowing use with different faces;

FIG. 30 is an illustration of a target where a portion of the POR is used for mounting;

FIG. 31 is an illustration of a target where the entire POR is used for mounting;

FIG. 32 is an illustration of a target where a dipole antenna is used as the point of reception; and

FIG. 33 is an illustration of a target where a monopole antenna is used as the point of reception.

### DETAILED DESCRIPTION OF THE INVENTION

A complete understanding of the invention will be obtained from the following description when taken in connection with the accompanying drawing figures wherein like reference characters identify like parts throughout.

For purposes of the description hereinafter, the terms “upper”, “lower”, “right”, “left”, “vertical”, “horizontal”, “top”, “bottom”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present invention pertains to a system 10 for wirelessly powering an item 12. The system 10 comprises a source 14 configured to send wireless power. The system 10 comprises a target 18 configured to receive the wireless power and convert the wireless power to a useable power. The system 10 comprises a component 22 connected to and configured to receive the useable power from the target 18, wherein when the component 22 receives the usable power, the component 22 activates and the active component 22 can be sensed by a person.

The present invention pertains to an assembly 24. The assembly 24 comprises a system 10 for wirelessly powering a component 22. The assembly 24 comprises a structure 26 for supporting the system 10. The system 10 includes a source 14 configured to send wireless power. The system 10 includes a target 18 electrically connected to the component 22 and configured to receive the wireless power, to convert the wireless power to a useable power, and to activate a component 22 using the useable power.

The present invention pertains to an item 12 that is wirelessly powered. The item 12 comprises a target 18 configured to receive wireless power and convert the wireless power to a useable power. The item 12 comprises a component 22 connected to and configured to receive the useable power from the target 18, wherein when the component 22 receives the usable power, the component 22 activates, and the active component 22 can be sensed by a person.

The present invention pertains to a method for wirelessly powering an item 12 comprising the steps of sending wireless power from a source 14. There is the step of receiving the wireless power at a target 18. There is the step of converting the wireless power to a useable power at the target 18. There is the step of receiving the useable power from the target 18 at a component 22 connected to the target 18. There is the step of activating by the component 22 when the component 22 receives the usable power, wherein the active component 22 can be sensed by a person.

The present invention pertains to a structure 26 for supporting. The structure 26 comprises a base 30. The structure 26 comprises an element 32 extending from the base 30 having a first portion 34 through which at least one wireless power transmitter 38 is attached to the element 32, and a second portion 36 through which at least one target 18 configured to receive the wireless power and convert the wireless power to a useable power is attached to the element 32.

The present invention pertains to a system 10 for wirelessly powering an item 12 attached to a tree. The system 10 comprises a source 14 configured to send wireless power. The system 10 comprises at least one target 18 configured to receive the wireless power and convert the wireless power to a useable power wherein the at least one target 18 is attached to the tree. The tree can be real or artificial

In regard to the description of the operation of the invention the following U.S. patents and patent applications are incorporated by reference.

U.S. Pat. No. 7,027,311

U.S. patent application Ser. No. 11/356,892

U.S. patent application Ser. No. 11/438,508

U.S. Patent Application No. 60/729,792

U.S. Patent Application No. 60/758,018

U.S. Patent Application No. 60/763,582

U.S. Patent Application No. 60/833,864

A system 10 for wirelessly powering an item 12 comprises a source 14 configured to send wireless power; a target 18 configured to receive the wireless power and convert the wireless power to a useable power; and a component 22 connected to and configured to receive the useable power from the target 18, wherein when the component 22 receives the usable power, the component 22 activates.

The system 10 wherein the source 14 includes a power transmitter 38.

The system 10 wherein the source 14 further includes a point of emission 16. The system 10 wherein the source 14 further includes a wired power source 14.

The system 10 wherein the target 18 includes a power receiver 40. The system 10 wherein the power receiver 40 includes a power harvester. The system 10 wherein the power harvester includes circuitry or components 22 configured to convert wireless power into usable power. The system 10 wherein the target 18 further includes a point of reception 20.

The system 10 wherein the component 22 includes a light.

The system 10 wherein the component 22 has moveable parts.

The system 10 wherein the component 22 produces a sound.

The system 10 wherein the component 22 produces a scent.

The system 10 wherein the component 22 includes a changeable surface characteristic.

The system 10 wherein the target 18 and the component 22 are incorporated into the item 12. The system 10 wherein the item 12 is an ornament 28. The system 10 wherein the item 12 is a snowflake. The system 10 wherein the snowflake is configured to hang in or on a surface. The system 10 wherein the surface is a window.

The system 10 further including one or more additional sources 14. The system 10 wherein the source 14 and the one or more additional sources 14 are connected. The system 10 wherein the source 14 and the one or more additional sources 14 are connected in series. The system 10 wherein the source 14 and the one or more additional sources 14 are connected in parallel.

The system 10 further including one or more additional targets 18. The system 10 wherein the target 18 and the one or more additional targets 18 are connected.

The system 10 further including one or more additional components 22. The system 10 wherein the component 22 and the one or more additional components 22 are connected.

The system 10 further including one or more controllers 64 electrically connected to the system 10 to control the system 10.

The system 10 further including one or more switches 50 electrically connected to the system 10 to aid with control of the system 10.

The system 10 wherein the source 14 includes an attachment mechanism for attaching to a structure 26.

The system 10 wherein the target 18 includes an attachment mechanism for attaching to a structure 26.

The system 10 wherein the component 22 includes an attachment mechanism for attaching to a surface.

An assembly 24, comprising a system 10 for wirelessly powering a component 22; and a structure 26 for supporting at least a portion of the system 10, wherein the system 10 includes: a source 14 configured to send wireless power; and a target 18 electrically connected to the component 22 and configured to receive the wireless power, to convert the wireless power to a useable power, and to activate a component 22 using the useable power.

The assembly 24 wherein the structure 26 is a tree.

The assembly 24 further including an item 12 incorporating the component 22. The assembly 24 wherein the item 12 further incorporates the target 18. The assembly 24 wherein the item 12 is an ornament 28.

The assembly 24 wherein the source 14 is positionable near a base 30 of the structure 26.

The assembly 24 wherein the target 18 is positionable on the structure 26.

The assembly 24 further including one or more additional sources 14.

The assembly 24 further including one or more additional targets 18.

The assembly 24 further including one or more additional components 22.

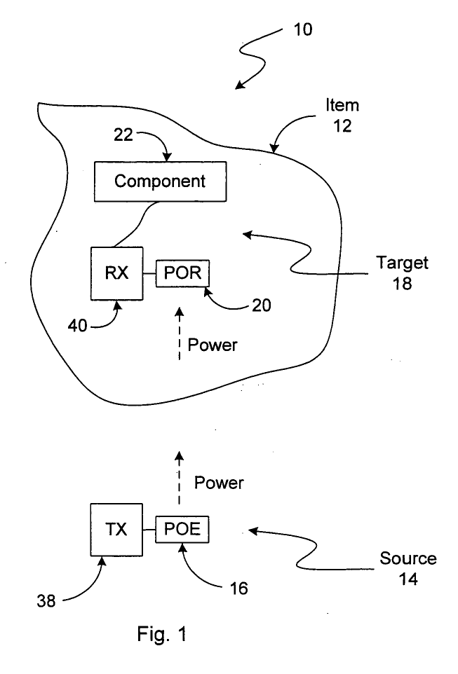

Referring to FIG. 1, a system 10 for wirelessly powering an item 12, according to the present invention, includes a source 14 for sending wireless power, a target 18 for receiving the wireless power and converting the wireless power into useable power, and a component 22 configured to receive and use the useable power.

The item 12 includes the component 22 or a plurality of components 22. The item 12 may be any specialty item 12 that requires power for the component 22 to activate. For example, the item 12 may be a decoration, a prop, a display, an accent, etc. The item 12 may be holiday or theme-related (e.g., Christmas, Easter, wedding, birthday). Activation of the component 22 may result in the production of a sensory change in the item 12, for example, light (sight), motion, sound, scent, taste, or touch (feel).

The item 12 may include a mechanism for hanging, mounting, or otherwise displaying the item 12. For example, the mechanism may be a clip, an aperture, etc.

The source 14 preferably includes a power transmitter 38 connected to a point of emission 16 (POE). The power transmitter 38 generates power and supplies the power to the point of emission 16. The point of emission 16 emits the power over a distance of space.

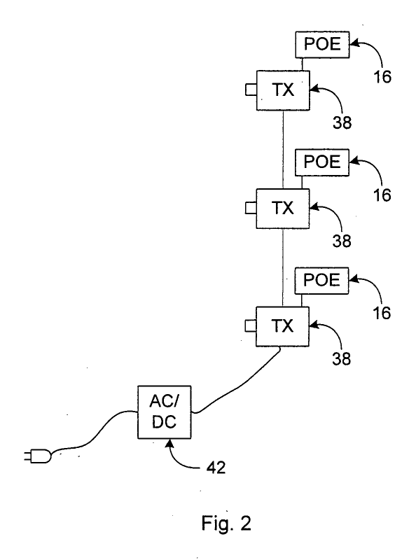

The source 14 may operate on batteries. Alternatively, referring to FIGS. 2-5, the source 14 may be electrically connected to a wired power source 14, for example, connected via a cord to a plug for plugging into a standard alternating current (AC) outlet. In this configuration, the power transmitter 38 converts AC power to the wireless power for transmission from the point of emission 16. An external AC to direct current (DC) converter 42 may be included to convert the AC power to DC power, so that the power transmitter 38 then converts the DC power into the wireless power.

One or more additional sources 14 (or portions thereof) may be included in the system 10. The sources 14 may be electrically connected to each other in any suitable manner to achieve a desired result. The sources 14 may be electrically connected in series or in parallel.

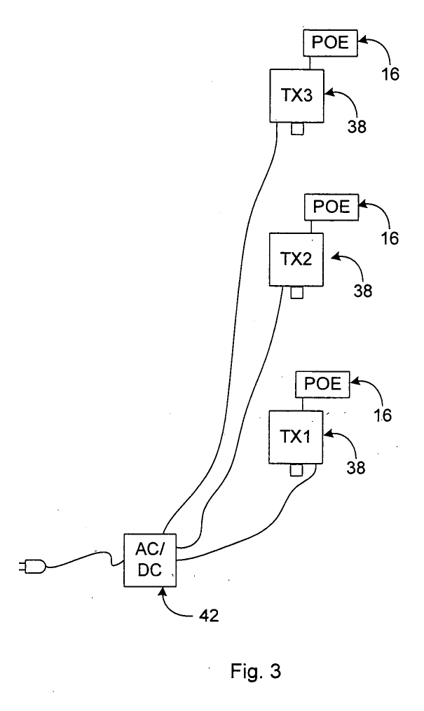

For example, one or more power transmitters 38, each with an associated point of emission 16, may be included. FIG. 2 illustrates a plurality of power transmitters 38 connected in series, where each power transmitter 38 is connected to a point of emission 16. FIG. 3 illustrates a plurality of power transmitters 38 connected in parallel, where each power transmitter 38 is connected to a point of emission 16.

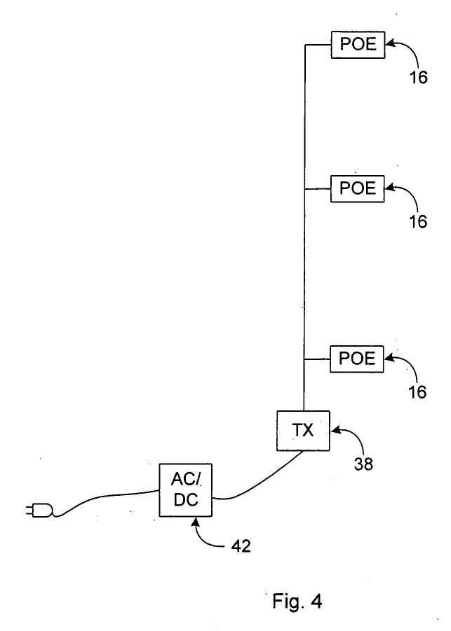

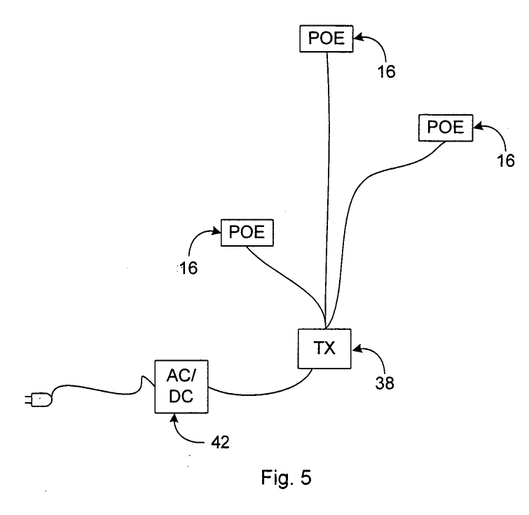

Likewise, for example, FIG. 4 illustrates one power transmitter 38 connected to a plurality of points of emission, where the points of emission are connected in series. FIG. 5 illustrates one power transmitter 38 connected to a plurality of points of emission, where the points of emission are connected in parallel.

The types of energy used with the point of emission 16 include, but are not limited to, RF (electromagnetic field), inductive (magnetic field), capacitive (electric field), visible light, infrared (IR) light, ultra-violet (UV) light, solar, subsonic, sonic, ultrasonic, vibration, wind, pressure (short and long wavelength), or any other type of energy. As such, a point of emission 16 may include an antenna 62, a coil, a plate, a light bulb, an LED 54, a laser, a diode, an IR detector, a UV bulb, a full spectrum light bulb, a speaker, a piezoelectric element 32, a vibrating element 32, a fan, and/or the like.

Referring to FIG. 1, the target 18 preferably includes a power receiver 40 connected to a point of reception 20 (POR). The point of reception 20 receives the emitted (wireless) power (from the point(s) of emission) and supplies the wireless power to the power receiver 40. The power receiver 40 converts the wireless power into a useable power (form) that is utilizable by the component 22. For example, the component 22 may require AC or DC power, or a combination of the two, for activation.

The power receiver 40 and the point of reception 20 may be of any design that accomplishes the objectives of the invention (i.e., receiving emitted power/energy from a source 14). The power receiver 40 and the point of reception 20 may be connected through any suitable means.

The power receiver 40 preferably includes a power harvester for converting wireless power to DC power.

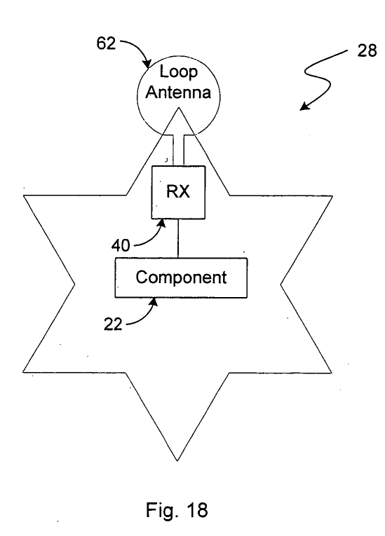

The point of reception 20 may be incorporated into the item 12 itself. For example, the point of reception 20 may be inside the item 12, part of the item 12, or outside the item 12. The point of reception 20 may be incorporated into the mechanism for hanging, mounting, or otherwise displaying the item 12. For example, a loop for hanging the item 12 may be a portion of or the entire point of reception 20, as shown in FIG. 18 where the loop for hanging is also an antenna 62 (point of reception 20) connected to the power receiver 40.

One or more additional targets 18 (or portions thereof) may be included in the system 10. The targets 18 may be electrically connected to each other in any suitable manner to achieve a desired result. The targets 18 may be electrically connected in series or in parallel.

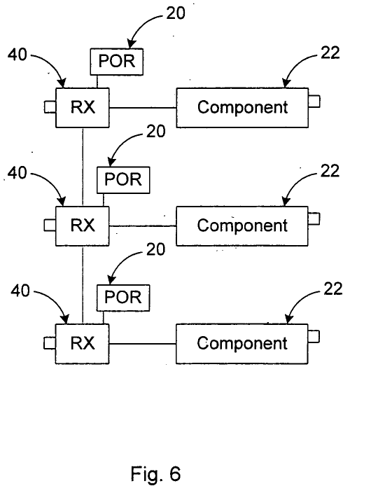

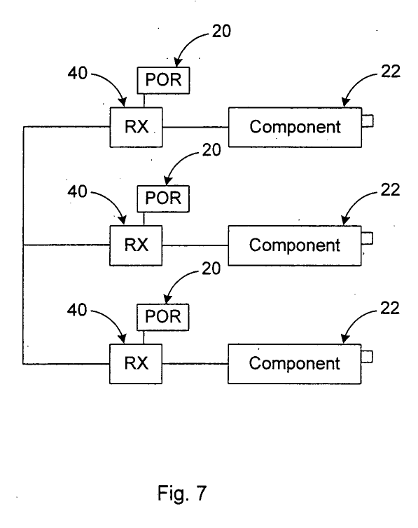

For example, one or more power receivers 40, each with an associated point of reception 20, may be included. FIG. 6 illustrates a plurality of power receivers 40 connected in series, where each power receiver 40 is connected to a point of reception 20. FIG. 7 illustrates a plurality of power receivers 40 connected in parallel, where each power receiver 40 is connected to a point of reception 20. In either case, the advantage is more uniform power distribution to the multiple components 22. As an example, one power receiver 40 may be oriented improperly or located in a location with no or low wireless power density. The result may be a reduced power output for that receiver 40. The other power receivers 40, however, may be receiving sufficient power and may supply some of that power to any other receiver 40 receiving less power.

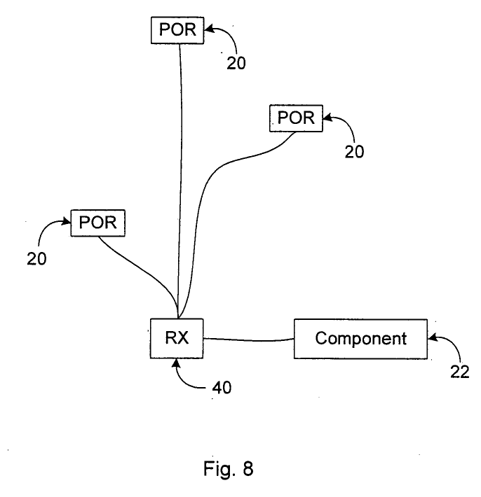

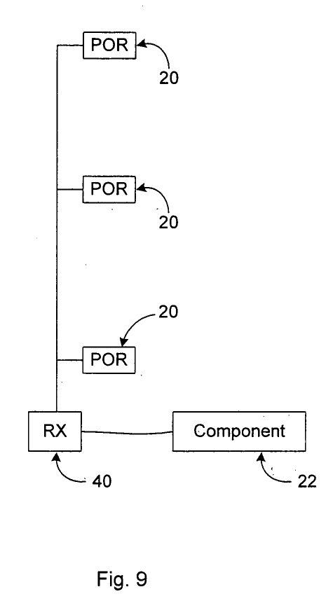

Likewise, for example, FIG. 8 illustrates one power receiver 40 connected to a plurality of points of reception, where the points of reception are connected in parallel. FIG. 9 illustrates one power receiver 40 connected to a plurality of points of reception, where the points of reception are connected in series. In either case, the advantages are increased power reception and increased probability of receiving sufficient power. As an example, one point of reception 20 may be oriented improperly or located in a location with no or low wireless power density. The result may be a reduced power output for that point of reception 20. The other points of reception, however, may be receiving sufficient power which is supplied to the power receiver 40. It should be noted that the multiple points of reception shown in any of the figures may be directly connected together or combined using a combiner or other combining device.

The types of energy used with the point of reception 20 include, but are not limited to, RF (electromagnetic field), inductive (magnetic field), capacitive (electric field), visible light, infrared (IR) light, ultra-violet (UV) light, solar, subsonic, sonic, ultrasonic, vibration, wind, pressure (short and long wavelength), or any other type of energy. As such, a point of reception 20 may include an antenna 62, a coil, a plate, an IR detector, a UV detector, a solar cell, a PIN diode, a wind mill, a fan, a transducer, a microphone, a piezoelectric element 32.

Referring to FIGS. 1 and 10-14, the component 22 is a part of or connected to the item 12. The component 22 may be anything that utilizes power for activation. Upon activation, the component 22 produces a result or desired outcome, such as a sensory change in the item 12. For example, the component 22 may use power to produce light, motion, sound, scent, taste, or tactile characteristics. To this end, the component 22 may be a light, an LED 54, a moveable part, a bell, etc. The component 22 may be configured to produce more than one characteristic.

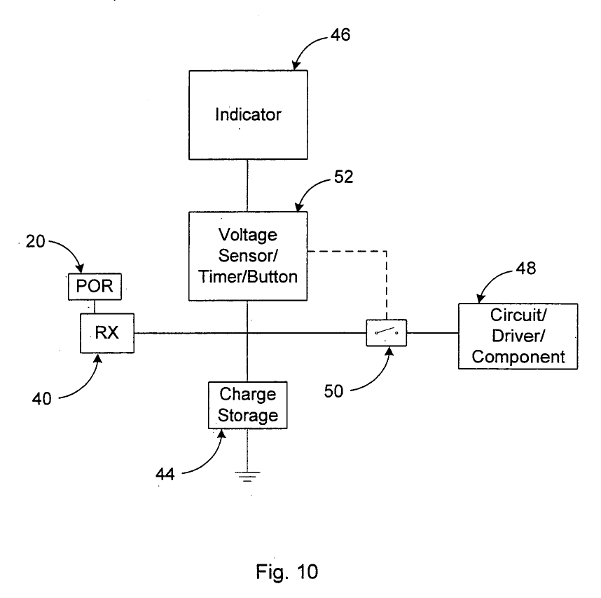

Referring to FIG. 10, the target 18 may also include a charge storage 44 component 22, means for activating the component 22, and a circuit or a driver 48, as appropriate. The charge storage 44 stores power to supply to the component 22. The means for activating the component 22 controls the activation of the component 22. The means may include a switch 50 that passes or accepts power to the component 22. The means may also include a voltage sensor 52 such that when a pre-determined voltage level is reached, the switch 50 is activated to allow power to flow to the component 22. The means may alternatively include a timer to control activation of the switch 50. The means may alternatively include a button or other means to allow a user to control activation of the switch 50.

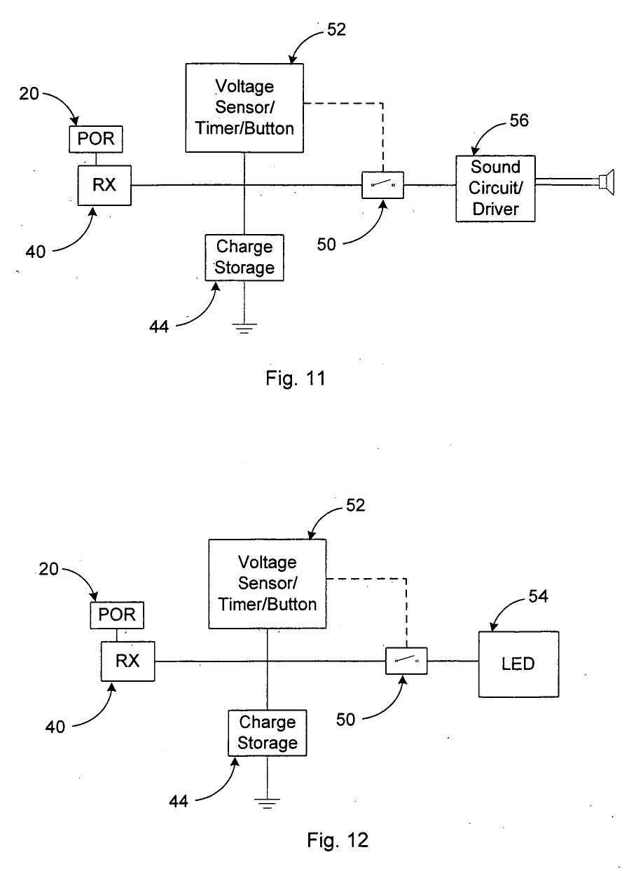

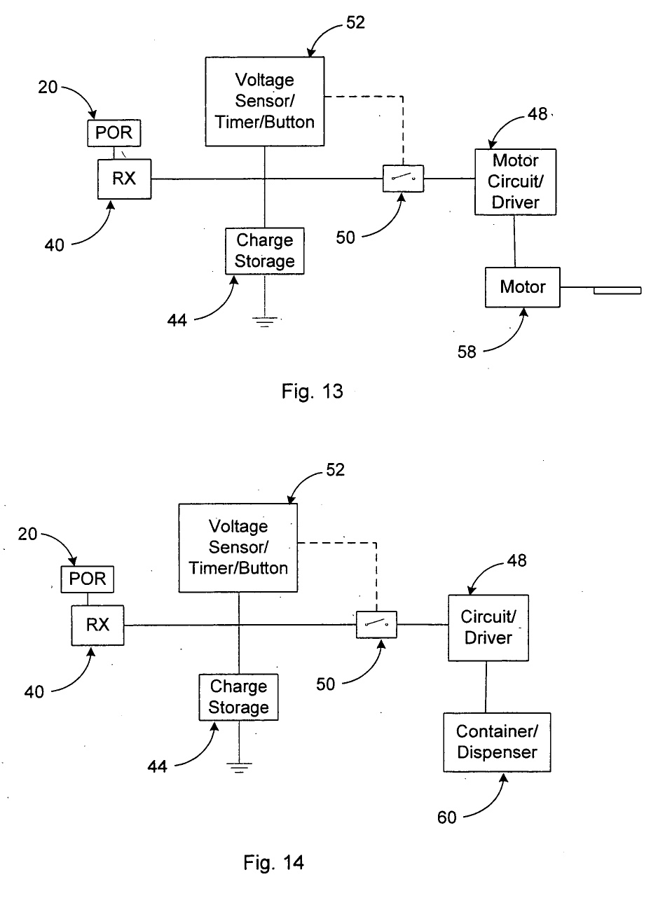

Referring to FIG. 11, with a component 22 for sound, a sound circuit 56 or driver 48 is included to control the operation of a speaker or other sound producing device. Referring to FIG. 12, with a component 22 for light, an LED 54, or other light producing device, is connected to the switch 50. The system 10 may be designed to blink the LED 54 on and off, to dim and bright the LED 54, and/or change the color. Referring to FIG. 13, with a component 22 for tactile characteristics, a motor circuit or driver 48 is connected to the switch 50 and to a tactile motor 58. Referring to FIG. 14, with a component 22 for taste or smell, such as a container 60 for a liquid or gas having an associated dispenser (for example, for passing flavored liquid into a drink or misting a scented gas into the air), a dispenser circuit or driver 48 is connected to the switch 50 and the dispenser. It should be noted that with each of these embodiments, the switch 50, timers/button or storage 44 is preferred to be used, but not necessary to be used.

One or more additional components 22 may be included in the system 10. The one or more components 22 may be configured to work together to achieve a desired outcome. The components 22 and/or targets 18 may be electrically connected to each other in any suitable manner to achieve a desired result. The components 22 may be electrically connected in series or in parallel.

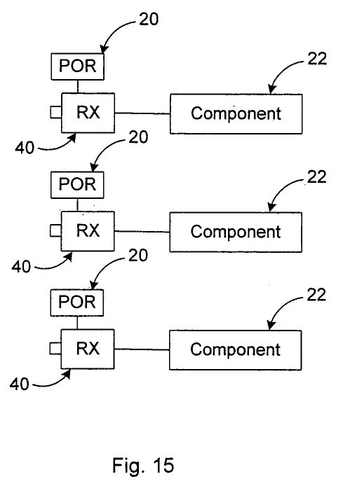

One or more components 22 may be individually utilized in the system 10. For example, FIG. 15 illustrates a plurality of components 22, where each component 22 is connected to one of a plurality of targets 18.

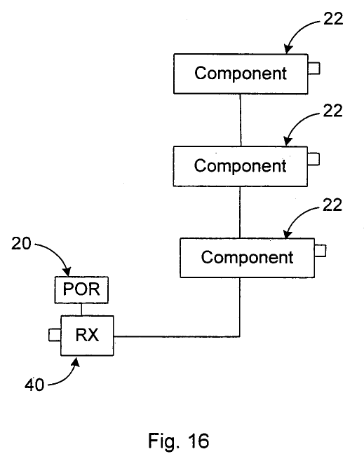

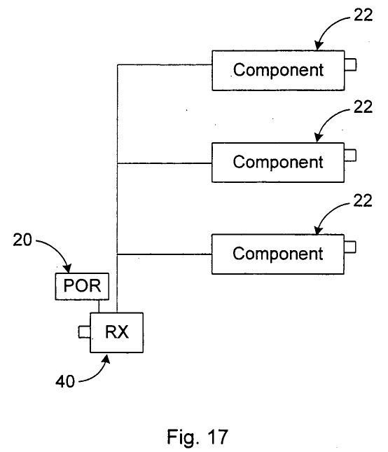

One or more components 22 may be connected to a single target 18. For example, FIG. 16 illustrates a plurality of components 22 connected to one power receiver 40, where the components 22 are connected in series. FIG. 17 illustrates a plurality of components 22 connected to one power receiver 40, where the components 22 are connected in parallel.

Likewise, one or more components 22 may be connected to one or more targets 18. FIG. 6 illustrates a plurality of components 22 connected to a plurality of power receivers 40, where the power receivers 40 are connected in series. FIG. 7 illustrates a plurality of components 22 connected to a plurality of power receivers 40, where the power receivers 40 are connected in parallel.

Referring to FIG. 18, the component 22 and the target 18 may be incorporated into the item 12. The item 12 may be an ornament 28 for a holiday tree (e.g., a lighted Christmas tree). The item 12 may also be a window decoration (e.g., a lighted snowflake). One or more items 12 may be configured to work together to achieve a desired outcome (e.g., a light or sound sequence). One or more items 12 may be electrically connected to each other to achieve the desired outcome.

The system 10 may be configured to pulse power. Pulsing may be used to turn on and off any point of emission 16 as desired. For example, each point of emission 16 of the system 10 may be turned on then off sequentially. The points of emission may turn on or off in a sequence that produces desired changes in the amount of power wirelessly supplied to the point of reception 20 and/or component 22. As an example, the points of emission may be used to wirelessly power lights on a Christmas tree. The points of emission may turn on and off in order to make different lights at different locations turn on and off to produce blinking and other stimulating light sequences. Pulsing of the points of emission may also be used to increase the range of the wireless power and/or efficiency of the conversion of wireless energy to a useable form. Pulsing methods are described in U.S. patent application Ser. No. 11/356,892 and U.S. Provisional Patent Application No. 60/758,018, both entitled Pulsing Transmission Method and incorporated herein by reference. Pulsing networks are described in U.S. patent application Ser. No. 11/356,892 and U.S. Provisional Patent Application No. 60/758,018, both entitled Pulsing Transmission Network and incorporated herein by reference.

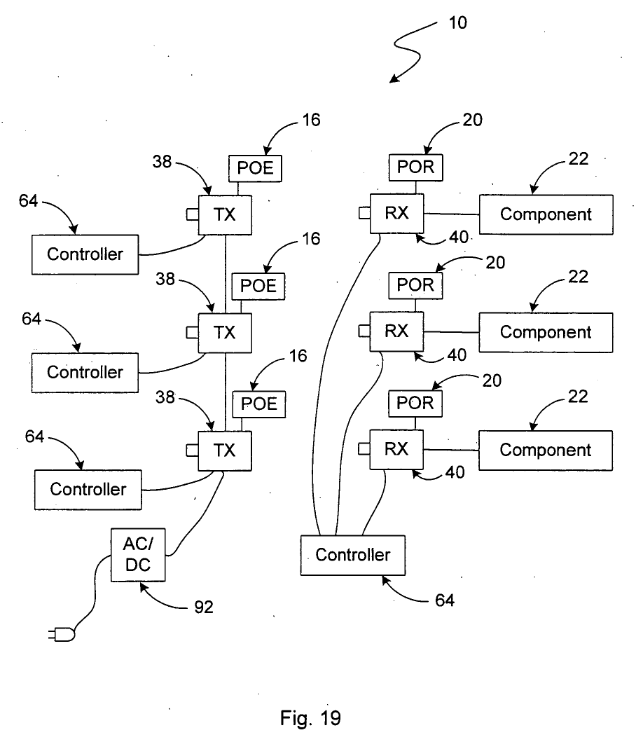

Referring to FIG. 19, a controller 64 may be incorporated into the system 10 to control a source 14, a target 18, a component 22, and/or an item 12 to achieve a desired outcome. One or more additional controllers 64 may be included. The one or more controllers 64 may be connected to one or more of the sources 14, targets 18, components 22, items 12, and/or each other. The controller 64 may be, but is not limited to, a microprocessor.

For example, a controller 64 may be used to pulse power by turning specific points of emission on and off. For another example, a controller 64 may be used to direct power to a particular target 18 via a particular source 14. The switch 50 may be, but is not limited to, a SPST or SPDT relay, pin diode switch 50, or a transistor such as a PMOS.

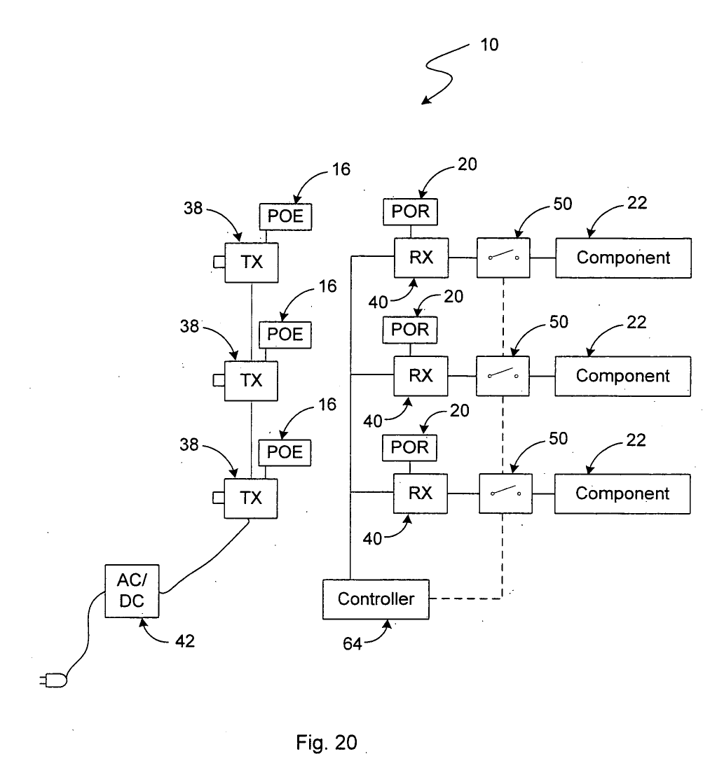

Referring to FIG. 20, a switch 50 may be incorporated into the system 10 to achieve a desired outcome. One or more additional switches 50 may be included. The one or more switches 50 may be connected to one or more of the sources 14, targets 18, components 22, items 12, controllers 64, and/or each other.

For example, a switch 50 may be used to pulse power by accepting and passing power at specific points of emission. For another example, a switch 50 may be used to accept or pass power to a particular target 18 via a particular source 14. For another example, as illustrated in FIG. 20, a plurality of switches 50 may be used to turn components 22 on and off.

In the present invention, the system 10 may be made up of any embodiment source 14, any embodiment target 18, and any embodiment component 22. Each of the source 14, target 18, and component 22 (of multiples of each) may be configured to perform individually or collaboratively. Thus, the system 10 is flexible so that a wide variety of desired outcomes are achievable.

Thus, for a holiday light application, the system 10 can be designed to have the lights on constantly, to turn individual lights on and off to create various patterns (blinking, sequences), to dim the lights, to change colors with different colored bulbs or LEDs 54. For a sound application, the system 10 can be designed to play various tunes by turning on and off the musical elements 32 in the appropriate order and for the appropriate duration.

The system 10 may be configured to recirculate excess or unused power. Heat generated by the system 10 may be captured and used by other sub-assemblies of the system 10. For example, to heat a potpourri sub-assembly 24 or to heat water in a base 30 of a Christmas tree (for potpourri). As another example, the heat may be harvested and turned into electrical energy which may be supplied back to the system 10.

It should be noted that various other electrical components 22 may be added as required by the system 10 or as desired. As an example, a series resistor may be added to the component 22 (e.g., LED 54) in order to limit current.

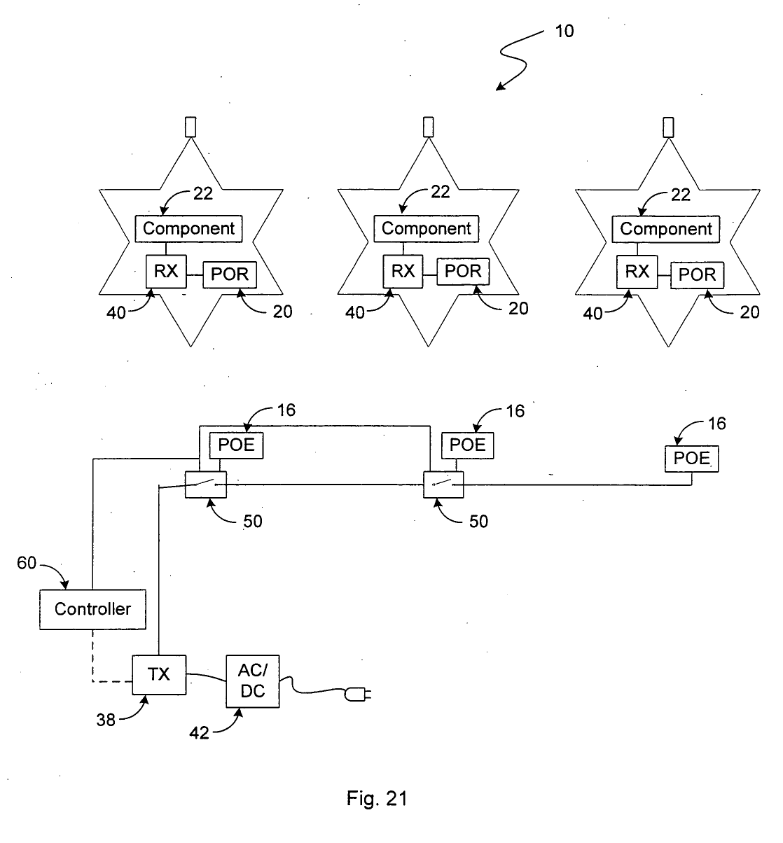

For example, referring to FIG. 21, a system 10 according to the present invention for wirelessly powering a plurality of items 12 is illustrated. The system 10 includes a source 14, a plurality of targets 18, and a plurality of components 22.

In this example, each of the plurality of items 12 is an illuminating snowflake. Each of the plurality of items 12 includes a target 18, a component 22, and a mechanism for hanging the item 12.

The source 14 is connected to a plug that engages an AC outlet. AC power is supplied via the plug to an AC to DC converter 42. The AC to DC converter 42 converts the AC power to DC power and supplies the DC power to a power transmitter 38. The power transmitter 38 converts the DC power to wireless power and supplies the wireless power to a plurality of points of emission via a plurality of switches 50. The controller 64 and the switches 50 direct the flow of power to the points of emission. The points of emission transmit the wireless power over a distance to the targets 18.

Each target 18 includes a point of reception 20 and a power receiver 40. Each point of reception 20 receives the wireless power sent by one or more points of emission. Each point of reception 20 supplies the wireless power to the power receiver 40 connected thereto. The power receiver 40 converts the wireless power to DC power and supplies the DC power to the component 22.

In this example, each component 22 is an LED 54 for illuminating its associated snowflake. Each LED 54 receives DC power from the power receiver 40 and is activated or turned on.

Thus, in this example system 10, a single source 14 is utilized to send power wirelessly to a series of snowflakes, causing the snowflakes to light up. The controller 64 may be configured to vary the intensities or colors of the LEDs 54, vary the durations that the LEDs 54 are lit up, vary the sequence of LED 54 lighting among the group of snowflakes, etc. As an example, each snowflake may have a timing circuit or microprocessor that cycles through a sequence of different colors, intensities, and/or durations. The sequence may be predetermined or random. The timer may be synchronized by a pulsing waveform from the power transmitter(s) 38. As an example, the power transmitter(s) 38 may pulse for ten seconds. This ten-second period may be followed by a 1 second off period in order to reset the timers in the power receivers 40. The snowflakes may function from stored energy during this off period or may turn off with the power transmitter 38.

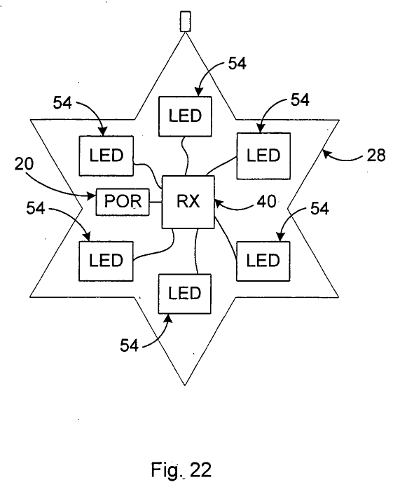

FIG. 22 shows another example of a snowflake suitable to be incorporated in the system 10 illustrated in FIG. 21. This snowflake includes a target 18 having a single power receiver 40, a point of reception 20, and multiple components 22 (LEDs 54).

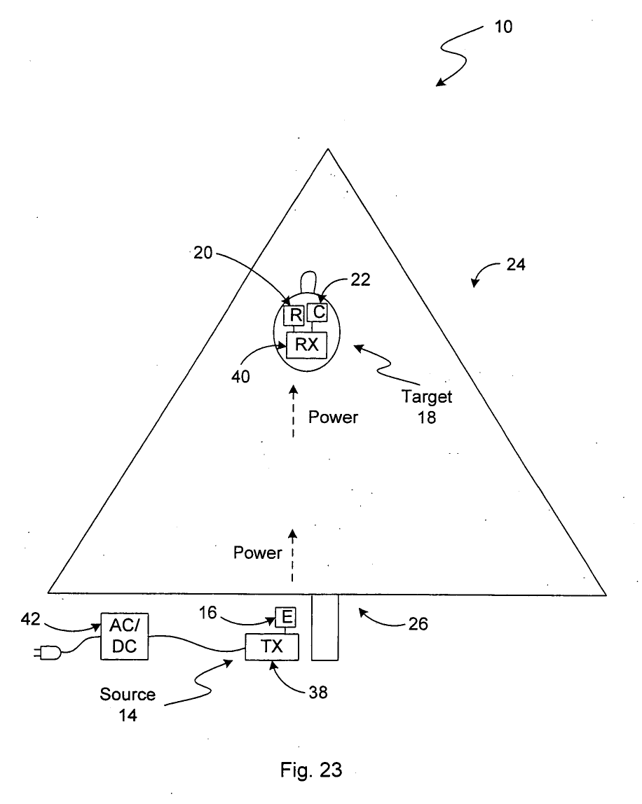

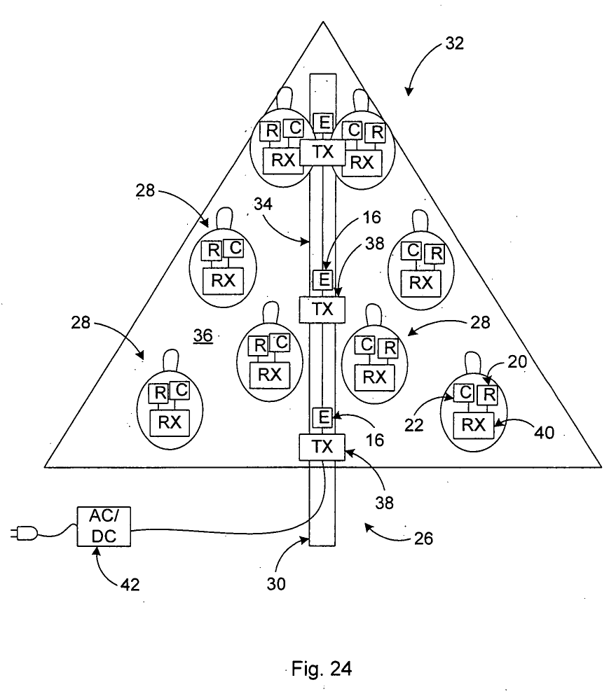

Referring to FIGS. 23-24, an assembly 24, according to the present invention, includes a system 10 for wirelessly powering an item 12 and a structure 26 for supporting at least a portion of the system 10.

The system 10 is any system 10 according to the present invention. The system 10 includes at least one source 14, at least one target 18, and at least one component 22. The structure 26 is any structure 26 capable of physically supporting any part or all of the system 10.

In the example illustrated in FIG. 23, the structure 26 is a Christmas tree. The system 10 includes a single source 14, a single target 18, and a single component 22. The target 18 and the component 22 are incorporated into the item 12 to be powered. For example, the item 12 may be an illuminating ornament 28, where the component 22 is an LED 54, or a musical ornament 28, where the component 22 is a music maker, such as a single recording of an MP3 player. The item 12 includes a loop for hanging the ornament 28 on the Christmas tree.

In the example illustrated in FIG. 24, the structure 26 is a Christmas tree. The system 10 includes a plurality of sources 14, a plurality of targets 18, and a plurality of components 22. One target 18 and one component 22 are incorporated into one item 12 to be powered. For example, the items 12 may be illuminating ornaments 28, where the components 22 are LEDs 54, or musical ornaments 28, where the components 22 are music makers. The items 12 include a loop for hanging the ornaments 28 on the Christmas tree.

It should be noted that this embodiment may be used with a real or artificial tree. The source 14 may be built into the tree or be an add-on product. The tree may have lights or strings of lights. There is, preferably, a string of lights (as an example, 4 LEDs 54) dedicated to each branch where the string of lights is wirelessly powered.

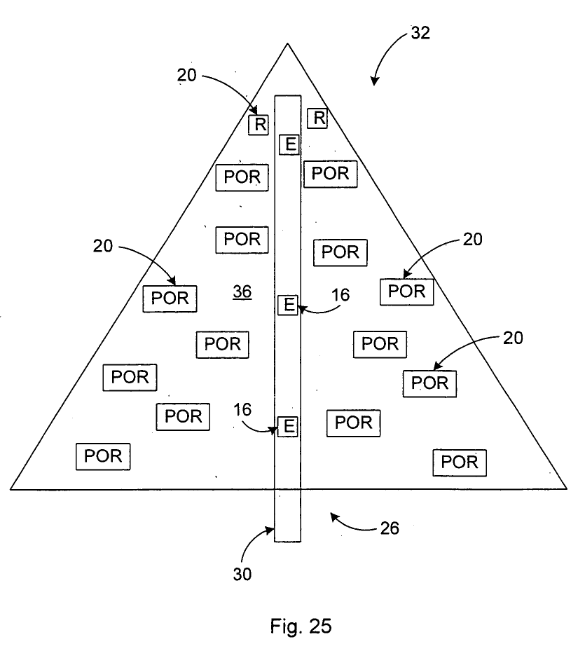

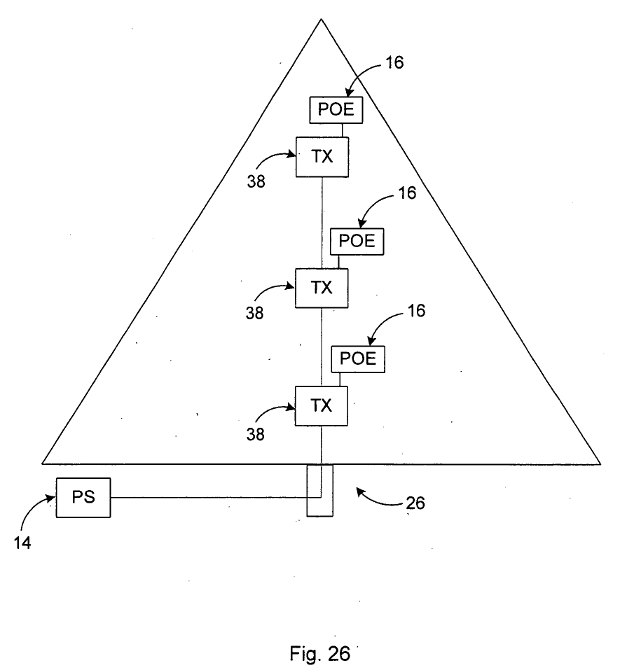

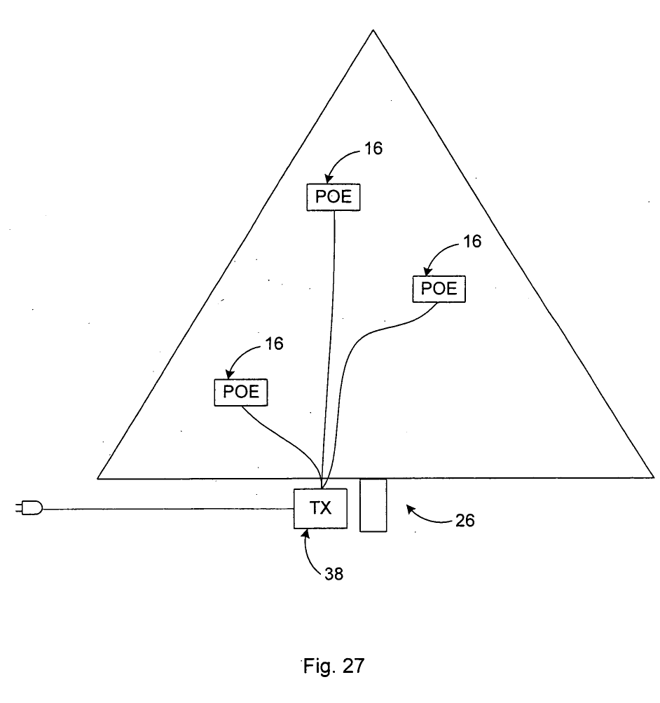

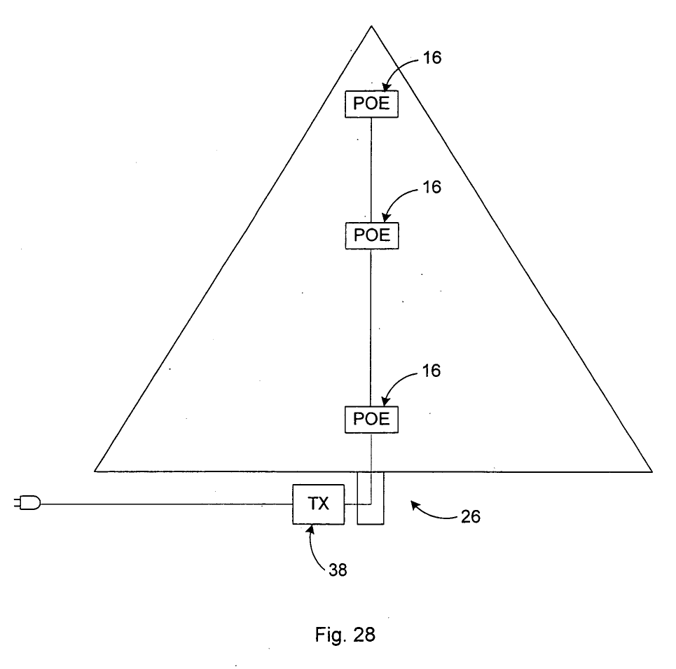

FIGS. 25-29 illustrate various possible variations of embodiments of the present invention (these examples are not meant to be limiting).

A remote control may be included to control operation of the system 10. For example, to turn the system 10 on and off, to vary the intensity or brightness of lights/LEDs 54. A timer or sensor 52 (e.g., light detector) may be included to control operation of the system 10.

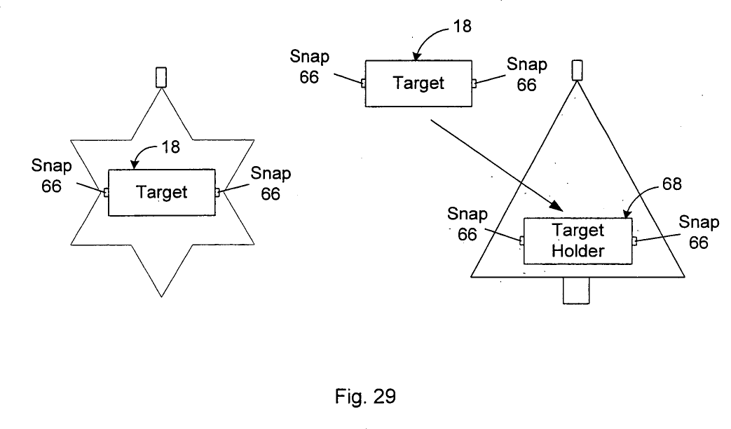

For any item 12 or source 14, a face (or body) of the item 12 or source 14 may be interchangeable with a second face for the item 12 or source 14. For example, if the item 12 is a snowflake, the face defining the snowflake may be removed and replaced with a jack-o-lantern, such that the item 12 may be used for multiple occasions. As a specific example, the item 12 may be designed to accept the target 18 (the point of reception 20 and the power receiver 40) that is formed as a rectangular unit that snaps into the face that defines the shape of the item 12. The resulting target 18 can then be removed from one item 12 by releasing securing snaps 66 and snapping the target 18 into a target holder 68 of the other item 12. An example of this can be seen in FIG. 29 where the faces or items 12 are a star and a tree.

Similarly, a target 18 may be interchangeable between various components 22 and/or items 12. This allows the target 18 to be used with a multitude of different components 22/items 12.

The system 10 may include a communication component in order to send data between parts of the system 10.

It should be noted that wireless power in any polarization, sense of rotation, magnitude, wavelength, or any other characteristic may be used in any of the embodiments to make the system 10, apparatus, or assembly 24 more robust in operation (work in any orientation, polarization, or position).

In any embodiment of the present invention, the power transmitted may be limited to include power only, that is, data is not present in the signal. If data is required by the application, the data is, preferably, transmitted separately and/or has a separate receiver 40, for example, via the communication component discussed above.

As an example, when inductive power is utilized in the present invention, magnetic energy is transferred from the source 14 to the target 18. The point of emission 16 is a coil, for example. The point of reception 20 is another coil. When inductive coupling is established between the coils, the coil of the point of reception 20 receives the wireless power (magnetic energy) from the coil of the point of emission 16.

Any of the embodiments discussed herein are applicable to an embodiment using inductive power, such as an assembly 24 including a coil(s) for the point of emission 16. For example, there may be a number of sources 14 within a structure 26 (tree) where each source 14 includes a coil. Or, for example, there may be one source 14 having a plurality of coils connected in series or parallel, where the coils are placed within the structure 26.

As an example, when capacitive power is utilized in the present invention, an electric field is transferred from the source 14 to the target 18. The point of emission 16 is a capacitive plate, for example. The point of reception 20 is another capacitive plate. When capacitive coupling is established between the plates, the plate of the point of reception 20 receives the wireless power (electric field) from the plate of the point of emission 16.

Any of the embodiments discussed herein are applicable to an embodiment using capacitive power, such as an assembly 24 including a capacitive plate for the point of emission 16. For example, there may be a number of sources 14 within a structure 26 (tree) where each source 14 includes a capacitive plate. Or, for example, there may be one source 14 having a plurality of capacitive plates connected in series or parallel, where the plates are placed within the structure 26.

As an example, when visible light is utilized in the present invention, wavelengths within the visible spectrum are transferred from the source 14 to the target 18. The point of emission 16 generates a light signal, for example, a light bulb or an LED 54. The point of reception 20 receives visible light and converts the light to a usable power, such as DC. For example, the point of reception 20 may be a solar cell. The point of reception 20 receives the wireless power (visible light) from the point of emission 16.

Any of the embodiments discussed herein are applicable to an embodiment using visible light, such as an assembly 24 including an LED 54 for the point of emission 16. For example, there may be a number of sources 14 within a structure 26 (tree) where each source 14 includes an LED 54. Or, for example, there may be one source 14 having a plurality of LEDs 54 connected in series or parallel, where the LEDs 54 are placed within the structure 26.

As an example, when infrared (IR) light is utilized in the present invention, wavelengths within the infrared spectrum are transferred from the source 14 to the target 18. The point of emission 16 generates an infrared signal, for example, an IR diode. The point of reception 20 receives infrared light and converts it to a usable power, such as DC. For example, the point of reception 20 may be an IR detector. The point of reception 20 receives the wireless power (infrared light) from the point of emission 16.

Any of the embodiments discussed herein are applicable to an embodiment using infrared light, such as an assembly 24 including an IR diode for the point of emission 16. For example, there may be a number of sources 14 within a structure 26 (tree) where each source 14 includes an IR diode. Or, for example, there may be one source 14 having a plurality of IR diodes connected in series or parallel, where the IR diodes are placed within the structure 26.

As an example, when heat is utilized in the present invention, heat is transferred from the source 14 to the target 18. The point of emission 16 generates heat, for example, a heating element 32. The point of reception 20 receives the heat and converts it to a usable power, such as DC. For example, the point of reception 20 may be a thermopile. The point of reception 20 receives the wireless power (heat) from the point of emission 16.

Any of the embodiments discussed herein are applicable to an embodiment using heat, such as an assembly 24 including a heating element for the point of emission 16. For example, there may be a number of sources 14 within a structure 26 (tree) where each source 14 includes a heating element. Or, for example, there may be one source 14 having a plurality of heating elements connected in series or parallel, where the heating elements are placed within the structure 26.

As an example, when ultraviolet (UV) light is utilized in the present invention, wavelengths within the ultraviolet spectrum are transferred from the source 14 to the target 18. The point of emission 16 generates an ultraviolet signal, for example, a light bulb that produces ultraviolet (not visible) light. The point of reception 20 receives ultraviolet light and converts it to a usable power, such as DC. For example, the point of reception 20 may be a photovoltaic cell. The point of reception 20 receives the wireless power (ultraviolet light) from the point of emission 16.

Any of the embodiments discussed herein are applicable to an embodiment using ultraviolet light, such as an assembly 24 including a UV light bulb for the point of emission 16. For example, there may be a number of sources 14 within a structure 26 (tree) where each source 14 includes a UV light bulb. Or, for example, there may be one source 14 having a plurality of UV light bulbs connected in series or parallel, where the UV light bulbs are placed within the structure 26.

As an example, when solar energy is utilized in the present invention, wavelengths within the ultraviolet, visible, and infrared spectrum are transferred from the source 14 to the target 18. The point of emission 16 generates solar energy (or a full spectrum light signal), for example, a full spectrum light bulb. The point of reception 20 receives full spectrum light and converts the light to a usable power, such as DC. For example, the point of reception 20 may be a full spectrum solar cell. The point of reception 20 may be a plurality of points of reception, where each point of reception 20 is configured to receive a particular type of energy. The points of reception receive the wireless power (full spectrum light) from point of emission 16.

Any of the embodiments discussed herein are applicable to an embodiment using solar energy, such as an assembly 24 including a full spectrum light bulb for the point of emission 16. For example, there may be a number of sources 14 within a structure 26 (tree) where each source 14 includes a full spectrum light bulb. Or, for example, there may be one source 14 having a plurality of full spectrum light bulbs connected in series or parallel, where the full spectrum light bulbs are placed within the structure 26.

As an example, when sound (subsonic, sonic, or ultrasonic waves) is utilized in the present invention, sound waves are transferred from the source 14 to the target 18. The point of emission 16 generates a sound wave, for example, a speaker. The point of reception 20 receives the sound waves and converts the sound to a usable power, such as DC. For example, the point of reception 20 may be a microphone. The point of reception 20 receives the wireless power (sound waves) from the point of emission 16.

Any of the embodiments discussed herein are applicable to an embodiment using sound, such as an assembly 24 including a speaker for the point of emission 16. For example, there may be a number of sources 14 within a structure 26 (tree) where each source 14 includes a speaker. Or, for example, there may be one source 14 having a plurality of speakers connected in series or parallel, where the speakers are placed within the structure 26.

As an example, when wind is utilized in the present invention, wind is transferred from the source 14 to the target 18. The point of emission 16 generates wind, for example, a fan. The point of reception 20 receives the wind and converts the wind to a usable power, such as DC. For example, the point of reception 20 may be a windmill. The point of reception 20 receives the wireless power (wind) from the point of emission 16.

Any of the embodiments discussed herein are applicable to an embodiment using wind, such as an assembly 24 including a fan for the point of emission 16. For example, there may be a number of sources 14 on a structure 26 (window sill) where each source 14 includes a fan. The target(s) 18 may be mounted on the structure 26 (window) to receive the wind current from the fan(s). Or, for example, there may be one source 14 having a plurality of fans connected in series or parallel, where the fans are placed within the structure 26.

As an example, when pressure is utilized in the present invention, pressure is transferred from the source 14 to the target. The point of emission 16 generates changes in pressure, for example, via a liquid in a sealed system 10. The point of reception 20 receives the changes in pressure and converts the changes in pressure to a usable power, such as DC. For example, the point of reception 20 may be a membrane connected to a pressure transducer. The point of reception 20 receives the wireless power (pressure) from the point of emission 16.

Any of the embodiments discussed herein are applicable to an embodiment using pressure, such as an assembly 24 including a pipe for transporting a liquid for the point of emission 16. For example, there may be a number of sources 14 in a structure 26 (pipe) where each source 14 includes a means to vary the pressure of the liquid in the pipe. The target(s) 18 may be mounted in the structure 26 (pipe) to receive the changes in pressure.

As an example, when vibration is utilized in the present invention, vibration is transferred from the source 14 to the target 18. The point of emission 16 generates a vibration, for example, a piezoelectric element 32. The point of reception 20 receives the vibration and converts the vibration to a usable power, such as DC. For example, the point of reception 20 may be a second piezoelectric element. The point of reception 20 receives the wireless power (vibration) from the point of emission 16.

Any of the embodiments discussed herein are applicable to an embodiment using vibration, such as an assembly 24 including a piezoelectric element 32 for the point of emission 16. For example, there may be a number of sources 14 within a structure 26 (on tree branches) where each source 14 includes a piezoelectric element 32. Vibration of the piezoelectric elements 32 would cause the branches to vibrate. The vibration would be received by second piezoelectric elements 32. Or, for example, there may be one source 14 having a plurality of piezoelectric elements 32 connected in series or parallel, where the piezoelectric elements 32 are placed within the structure 26.

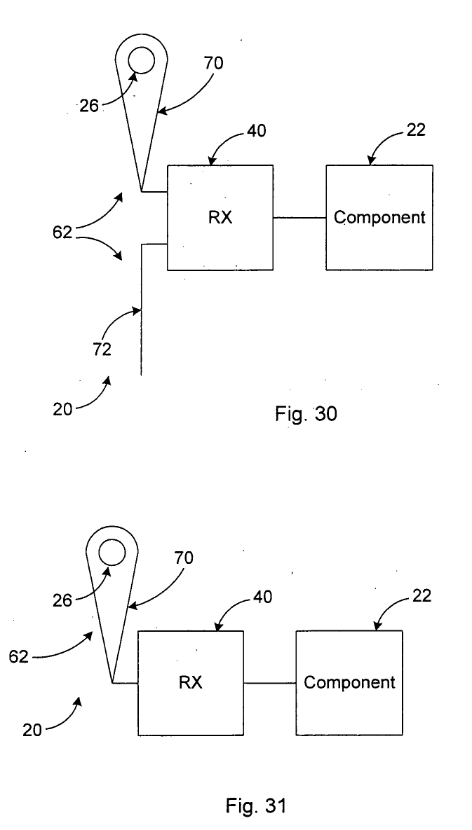

FIG. 30 illustrates where a portion of the POR 20 is used for mounting. The POR, in this case a dipole antenna, consists of a piece of wire 70 to make up half of the antenna 62, and a rigid section 72 to make up the second half of the antenna 62. The wire 70 may be cut to length to tune the antenna to 50 ohms. The POR is then hung on a structure 26 such as a branch or dowel. The weight of the receiver 40 and component 22 and rigid section 72 of antenna 62 then adds tension to the wire 70 allowing it to achieve the appropriate length for appropriate tuning, and alignment to the POE (not shown).

FIG. 31 illustrates where the entire POR 20 is used for mounting. The POR 20—in this case may be a monopole, loop, or other type of single element antenna 62—consists of a piece of wire 70 to make up the entire antenna 62. The wire 70 may be cut to length to tune the antenna 62 to 50 ohms. The POR is then hung on a structure 26 such as a branch or dowel. The weight of the receiver 40 and component 22 may add tension to the wire 70 allowing it to achieve the appropriate length for appropriate tuning, and alignment to the POE (not shown).

FIG. 30 illustrates where a portion of the POR 20 is used for mounting. The POR 20, in this case a dipole antenna 62, consists of a piece of wire 70 to make up half of the antenna 62, and a rigid section 72 to make up the second half of the antenna 62, which may be wire 70, a printed circuit board, or other conductive element. The wire 70 may be cut to length to tune the antenna 62 to 50 ohms, and the gauge of the wire 70 may be selected so that it is strong enough to support the weight of the ornament 28. The POR 20 is then hung on a structure 26 such as a branch or dowel. The weight of the receiver 40 and component 22 and rigid section 72 of antenna 62 then add tension to the wire 70 allowing it to maintain the appropriate length for appropriate tuning, and alignment to the POE (not shown).

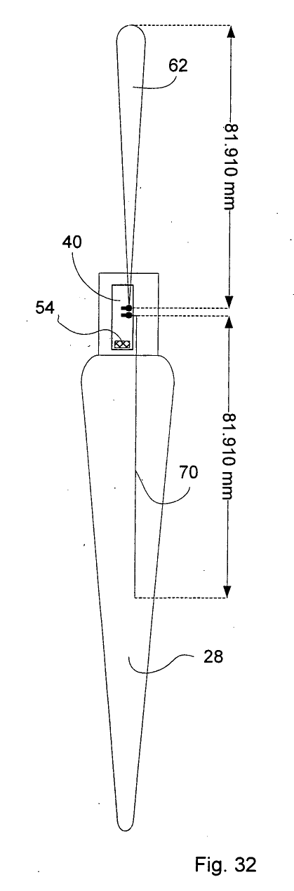

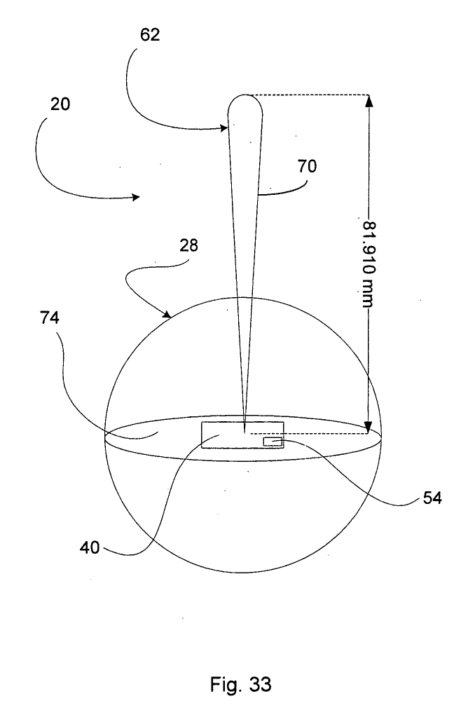

As an example in FIG. 32, a dipole antenna 62 is used as the POR 20. As RF energy is received at the POR 20, it is converted to DC power by the receiver 40 and used by an LED 54 to light the ornament 28. The top half of the dipole antenna 62 is a 30 AWG stranded wire with green insulation that forms a folded loop. This wire is used because it is strong enough to support the ornament 28, yet thin enough to be discrete and look like string or an ornament hook. The rigid section of the dipole antenna 62 is also 30 AWG stranded wire 70, though white insulation is used to make the wire 70 less visible. To tune the dipole both the length of the folded loop and the rigid wire 70 must be one quarter of the wavelength of the desired frequency of operation. For the example shown in FIG. 32, the frequency of operation is 915 MHz. One quarter of a 915 MHz wavelength is 81.910 mm. To tune the loop of the dipole, an appropriate length of wire is used so that when the ornament 28 is being supported by the wire as it is hung on the branch the quarter wavelength distance is measured from the connection point on the receiver 40 to the horizontal tangent of the loop. If a different material is used for the rigid section of the antenna 62 the dielectric will need to be taken into account when selecting the length of the conductive portion.

FIG. 31 illustrates where the entire POR 20 is used for mounting. The POR 20—in this case, may be a monopole, loop, or other type of single element antenna 62—consists of a piece of wire 70 to make up the entire antenna 62. The wire 70 may be cut to length to tune the antenna 62 to 50 ohms. The POR 20 is then hung on a structure 26, such as a branch or dowel. The weight of the receiver 40 and component 22 and may add tension to the wire 70 allowing it to achieve the appropriate length for appropriate tuning, and alignment to the POE (not shown).

As an example in FIG. 33, a monopole antenna 62 is used as the POR 20. As RF energy is received at the POR, it is converted to DC power by the receiver 40 and used by an LED 54 to light the ornament 28. The monopole antenna is a 30 AWG stranded wire 70 with green insulation. This wire 70 is used because it is strong enough to support the ornament 28, yet thin enough to be discrete and look like string or an ornament hook. The ground plane 74 for the monopole and the receiver 40 are a single item, though they are shown separately in FIG. 33 for clarity. To tune the monopole the length of the wire 70 formed was a folded loop must be one quarter of the wavelength of the desired frequency of operation. For the example shown in FIG. 33, the frequency of operation is 915 MHz. One quarter of a 915 MHz wavelength is 81.910 mm. To tune the monopole, an appropriate length of wire 70 is used so that when the ornament 28 is being supported by the wire 70 as it is hung on the branch the quarter wavelength distance is measured from the connection point on the receiver 40 to the horizontal tangent of the wire loop.

It will be understood by those skilled in the art that while the foregoing description sets forth in detail preferred embodiments of the present invention, modifications, additions, and changes might be made thereto without departing from the spirit and scope of the invention.

The invention claimed is:

1. A system for wirelessly powering an item, comprising:
a source including a point of emission and configured to send wireless power;
a target including a point of reception and configured to receive the wireless power and convert the wireless power to a useable power; and
a component connected to and configured to receive the useable power from the target, wherein when the component receives the usable power, the component activates and the active component can be sensed by a person.

2. A system as described in claim 1 wherein the source includes a power transmitter.

3. A system as described in claim 2 wherein the source further includes a wired power source.

4. A system as described in claim 3 wherein the target includes a power receiver.

5. A system as described in claim 4 wherein the power receiver includes a power harvester.

6. A system as described in claim 5 wherein the power harvester includes circuitry or components configured to convert wireless power into usable power.

7. A system as described in claim 1 wherein the component includes a light.

8. A system as described in claim 1 wherein the component has moveable parts.

9. A system as described in claim 1 wherein the component produces a sound.

10. A system as described in claim 1 wherein the component produces a scent.

11. A system as described in claim 1 wherein the component includes a changeable surface characteristic.

12. A system as described in claim 1 wherein the target and the component are incorporated into the item.

13. A system as described in claim 1 wherein the item is an ornament.

14. A system as described in claim 1 wherein the item is a snowflake shape.

15. A system as described in claim 14 wherein the snowflake shape is configured to be supported by a surface.

16. A system as described in claim 15 wherein the surface is a window.

17. A system as described in claim 1 including one or more additional sources.

18. A system as described in claim 17 wherein the source and the one or more additional sources are connected.

19. A system as described in claim 18 wherein the source and the one or more additional sources are connected in series.

20. A system as described in claim 18 wherein the source and the one or more additional sources are connected in parallel.

21. A system as described in claim 20 including one or more additional targets.

22. A system as described in claim 21 wherein the target and the one or more additional targets are connected.

23. A system as described in claim 1 including one or more additional components.

24. A system as described in claim 23 wherein the component and the one or more additional components are connected.

25. A system as described in claim 1 including one or more controllers electrically connected to the system to control the system.

26. A system as described in claim 1 including one or more switches electrically connected to the system to aid with control of the system.

27. A system as described in claim 1 wherein the source includes an attachment mechanism for attaching to a structure.

28. A system as described in claim 1 wherein the target includes an attachment mechanism for attaching to a structure.

29. A system as described in claim 1 wherein the component includes an attachment mechanism for attaching to a surface.

30. A system as described in claim 1 wherein the source operates on batteries.

31. A system as described in claim 2 wherein the wireless power transmitter pulses power wirelessly.

32. A system as described in claim 7 including a switch which controls the light.

33. A system as described in claim 32 wherein the light is an LED.

34. A system as described in claim 1 wherein the target includes a charge storage element which stores power to supply to the component.

35. A system as described in claim 34 including means for activating the component.

36. A system as described in claim 35 wherein the activating means includes a switch that passes or accepts power to the component.

37. A system as described in claim 36 wherein the activating means includes a voltage sensor such that when a predetermined voltage level is reached, the switch is activated to allow power to flow to the component.

38. A system as described in claim 36 wherein the activating means includes a timer to control activation of the switch.

39. A system as described in claim 36 wherein the activating means includes a button to control activation of the switch.

40. A system as described in claim 9 wherein the component includes a speaker.

41. A system as described in claim 40 wherein the component includes a driver to control the speaker.

42. A system as described in claim 1 wherein the item has an orb shape.

43. A system as described in claim 1 including a housing having a face, and the target is replaceable unit that fits in the face.

44. A system as described in claim 4 wherein the receiver converts usable power to DC.

45. A system as described in claim 4 wherein the receiver includes an antenna.

46. An assembly comprising:
a system for wirelessly powering a component; and
a structure for supporting the system,
wherein the system includes:
a source including a point of emission and configured to send wireless power; and
a target including a point of reception and electrically connected to the component and configured to receive the wireless power, to convert the wireless power to a useable power, and to activate a component using the useable power.

47. An item that is wirelessly powered comprising:
a point of reception configured to receive wireless power and convert the wireless power to a useable power; and
a component connected to the point of reception and configured to receive the useable power, wherein when the component receives the usable power, the component activates.

48. The item described in claim 47, wherein the item is an ornament.

49. A method for wirelessly powering an item comprising the steps of:
sending wireless power from a point of emission connected to a source;
receiving the wireless power at a point of reception connected to a target;
converting the wireless power to a useable power at the target;
receiving the useable power from the target at a component connected to the target; and
activating by the component when the component receives the usable power, wherein the active component can be sensed by a person.

50. A structure comprising:
a base:
an element extending from the base having a first portion through which at least one wireless power transmitter is attached to the element, and a second portion through which at least one target configured to receive the wireless power and convert the wireless power to a useable power is attached to the element.

51. A system for wirelessly powering an item attached to a tree comprising
a source configured to send wireless power from a point of emission; and
at least one target configured to receive the wireless power at a point of reception and convert the wireless power to a useable power wherein the at least one target is attached to the tree.
